(19) United States
(12) Patent Application Publication
(10) Pub. No.: US 2014/0001980 A1
(43) Pub. Date: Jan. 2, 2014

(54) CIRCUIT AND METHOD FOR DRIVING LED LIGHT

(71) Applicant: Samsung Electro-Mechanics Co., Ltd., Gyeonggi-do (KR)

(72) Inventors: Deuk Hee Park, Gyeonggi-do (KR); Sang Hyun Cha, Gyeonggi-do (KR); Youn Joong Lee, Gyeonggi-do (KR); Chang Seok Lee, Gyeonggi-do (KR)

(21) Appl. No.: 13/929,737

(22) Filed: Jun. 27, 2013

(30) Foreign Application Priority Data
Jun. 28, 2012 (KR) 10-2012-0070050

(51) Int. Cl. H05B 33/08

(52) U.S. Cl. CPC H05B 33/0845
USPC 315/307

(57) ABSTRACT

Disclosed herein are a circuit and a method for driving LED light. There is provided a circuit for driving LED light, including: a dimming block comparing line voltage supplied to the LED light with reference voltage to output a peak value of voltage charged according to a comparison signal as a first reference signal; a reference signal generation block comparing the first reference signal output from the dimming block with a peak value of sensing voltage sensing current of an LED driving switch to amplify an error and multiplying the line voltage by the error amplified signal so as to be output as a second reference signal; and a PWM control block comparing the second reference signal output from the reference signal generation block with the sensing voltage to output a PWM signal with controlled duty. In addition, a method for driving LED light is proposed.

### CROSS REFERENCE(S) TO RELATED APPLICATIONS

This application claims the benefit under 35 U.S.C. Section 119 of Korean Patent Application Serial No. 10-2012-0070050, entitled “Circuit And Method For Driving LED Light” filed on Jun. 28, 2012, which is hereby incorporated by reference in its entirety into this application.

### BACKGROUND OF THE INVENTION

1. Technical Field

The present invention relates to a circuit and a method for driving LED light, and more particularly, to a circuit and a method for driving LED light for changing a PWM reference signal according to line voltage.

2. Description of the Related Art

Generally, a light emitting diode (LED) that is an environment-friendly has been interested in various fields such as a lighting field, and the like. For example, an LED element generating short-wavelength series light has been actively applied to a light emitting device for lighting that couples with a specific phosphor or a combination of phosphors to provide white light. When the LED is used as lighting, the LED has advantages of long lifespan, low power, and the like. As a result, it is expected that the LED light replaces a bulb and a fluorescent lamp.

The LED light apparatus adopts a driving apparatus so as to control luminance of a desired light source. The apparatus for driving an LED according to the related art switches current to a magnitude in current of a reference level by a switch according to a signal-processed dimming signal so as to control luminance and intermits current flowing in the LED to drive the LED and control dimming. As the dimming signal, a pulse width modulation (PWM) dimming signal has been mainly used. As in the related art, when the output from the driving apparatus is dimming-controlled by a dimming signal input from the outside, an additional circuit is required and cost of a product is increased overall.

In this case, there is a need to design a circuit for driving an LED capable of interchanging triac dimmer that is installed in a home, a hotel, an office, and the like.

However, in order to generate the PWM control signal, when the PWM reference signal comparing with a sensing voltage CS signal sensing current of a switch for driving an LED is fixed, the triac dimmer may not be interchanged.

### PRIOR ART DOCUMENT

### Patent Document

(Patent Document 1) US Patent Laid-Open Publication No. US20110285301 (Laid-Open Publication Date: Nov. 24, 2011)
(Patent Document 2) US Patent Laid-Open Publication No. US20110140620 (Laid-Open Publication Date: Jun. 16, 2011)

### SUMMARY OF THE INVENTION

An object of the present invention is to provide a circuit and a method for driving LED light for changing a PWM reference signal according to line voltage.

According to an exemplary embodiment of the present invention, there is provided a circuit for driving LED light, including: a dimming block comparing line voltage supplied to the LED light with reference voltage to output a peak value of voltage charged according to a comparison signal as a first reference signal; a reference signal generation block comparing the first reference signal output from the dimming block with a peak value of sensing voltage sensing current of an LED driving switch to amplify an error and multiplying the line voltage by the error amplified signal so as to be output as a second reference signal; and a PWM control block comparing the second reference signal output from the reference signal generation block with the sensing voltage to output a PWM signal with controlled duty.

The dimming block may include: a comparison unit comparing the line voltage with the reference voltage to output the comparison signal; a charging voltage generation unit receiving current from a constant current source according to the comparison signal output from the comparison unit to perform charging; and a first sample and hold circuit unit maintaining the peak value of one period of the charging voltage output from the charging voltage generation unit so as to be output as the first reference signal.

The charging voltage generation unit may include: a constant current source supplying current; a switch performing switching according to the comparison signal output from the comparison unit; and a charging capacitor connected with the switch in parallel and receiving and charging the current from the constant current source at the time of operating a turn off of the switch.

The reference signal generation block may include: a second sample and hold unit maintaining and outputting the peak value of one period of the sensing voltage sensing the current of the LED driving switch; an error amplification unit amplifying and outputting an error by comparing an output signal from the second sample and hold unit with the first reference signal output from the dimming block; and a multiplication unit multiplying the line voltage by the error amplified signal output from the error amplification unit so as to be output as the second reference signal.

The PWM control block may include a PWM comparator and the PWM comparator may receive the second reference signal output from the reference signal generation block as a reference signal and the sensing voltage as a comparison signal to compare the second reference signal with the sensing voltage and output the PWM signal with the controlled duty.

The circuit for driving LED light may further include: a line voltage sensing block sensing the line voltage supplied to the LED light, wherein the line voltage supplied to the dimming block and the reference signal generation block is voltage sensed by the line voltage sensing block.

The line voltage supplied to the LED light may be output voltage from a dimmer.

According to another exemplary embodiment of the present invention, there is provided a method for driving LED light, including: a step of outputting a first reference signal to compare line voltage supplied to the LED light with reference voltage to output a peak value of voltage charged according to a comparison signal as a first reference signal; a step of generating a second reference signal to amplify an error by comparing the first reference signal output in the step of outputting a first reference signal with a peak value of sensing voltage sensing current of an LED driving switch and multiply the line voltage by the error amplified signal so as to be output as a second reference signal; and a step of controlling PWM to output a PWM signal with controlled duty by comparing the second reference signal output in the step of generating a second reference signal with the sensing voltage.

The step of outputting a first reference signal may include: a step of comparing the line voltage with the reference voltage to output the comparison signal; a step of generating charging voltage to perform charging by receiving current from a constant current source according to the comparison signal output in the comparing step; and a step of performing first sample and hold to maintain the peak value of one period of the charging voltage output after being charged in the charging voltage generating step so as to be output as the first reference signal.

The step of generating a second reference signal may include: a step of performing second sample and hold to maintain and output the peak value of one period of the sensing voltage sensing the current of the LED driving switch; a step of amplifying and outputting an error by comparing a signal output in the step of performing second sample and hold with the first reference signal output in the step of outputting a first reference signal; and a step of multiplying the line voltage by the error amplified signal output in the step of amplifying an error so as to be output as the second reference signal.

In the step of controlling PWM, by the PWM comparator, the second reference signal output in the second reference signal generating step may be received as a reference signal of a PWM comparator and the sensing voltage may be received as a comparison signal of the PWM comparator to compare the second reference signal with the sensing voltage and output the PWM signal with the controlled duty.

The line voltage supplied to the LED light may be output voltage from a dimmer.

### BRIEF DESCRIPTION OF THE DRAWINGS

FIG. 1 is a circuit diagram schematically showing a circuit for driving LED light according to an embodiment of the present invention.

FIG. 2 is a graph showing signals for each section in a dimming block of the circuit for driving LED light shown in FIG. 1.

FIG. 3 is a graph showing a signal in a reference signal generation block of the circuit for driving LED light shown in FIG. 1.

FIG. 4 is a flow chart schematically showing a method for driving LED light according to another exemplary embodiment of the present invention.

FIG. 5 is a flow chart schematically showing some processes of a method for driving LED light according to another exemplary embodiment of the present invention.

FIG. 6 is a flow chart schematically showing some other processes of a method for driving LED light according to another exemplary embodiment of the present invention.

### DESCRIPTION OF THE PREFERRED EMBODIMENTS

Exemplary embodiments of the present invention for accomplishing the above-mentioned objects will be described with reference to the accompanying drawings. In describing exemplary embodiments of the present invention, the same reference numerals will be used to describe the same components and an additional description that is overlapped or allow the meaning of the present invention to be restrictively interpreted will be omitted.

In the specification, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

First, a circuit for driving LED light according to a first exemplary embodiment of the present invention will be described in detail with reference to the accompanying drawings. In this case, reference numerals that are not shown in the accompanying drawings may be reference numerals in other drawings showing the same configuration.

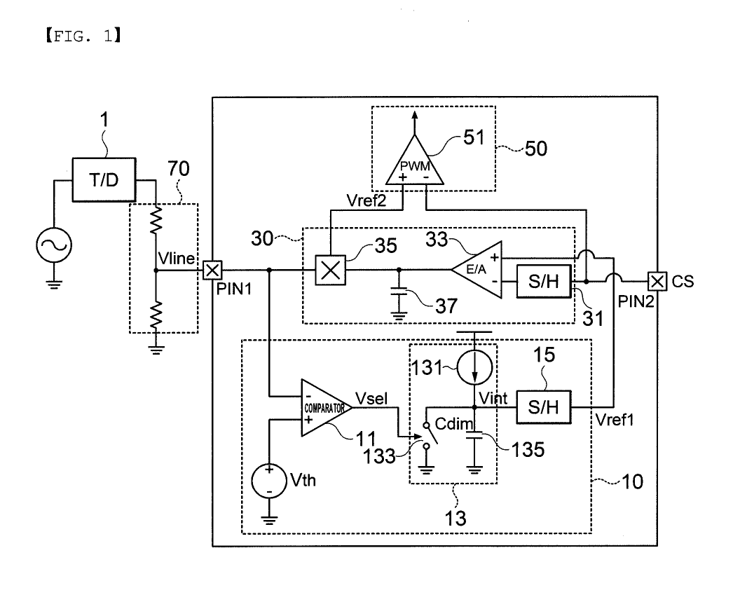

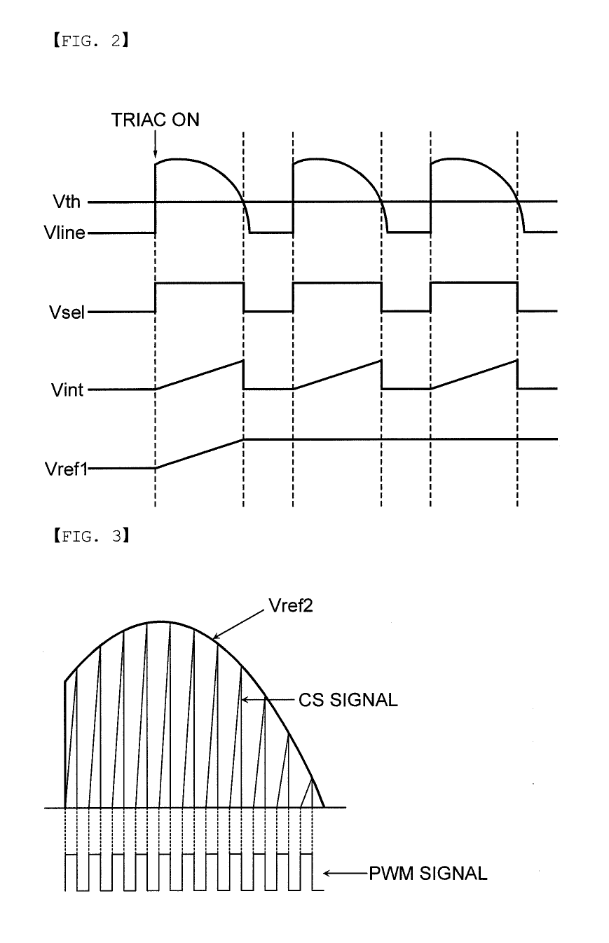

FIG. 1 is a circuit diagram schematically showing a circuit for driving LED light according to an embodiment of the present invention. FIG. 2 is a graph showing signals for each section in a dimming block of the circuit for driving LED light shown in FIG. 1 and FIG. 3 is a graph showing a signal in a reference signal generation block of the circuit for driving LED light shown in FIG. 1.

Referring to FIG. 1, a circuit for driving LED light according to a first exemplary embodiment of the present invention may be configured to include a dimming block 10, a reference signal generation block 30, and a PWM control block 50. According to another exemplary embodiment of the present invention, the circuit for deriving LED light may further include a line voltage sensing block 70.

In addition, in an example, the line voltage supplied to the LED light (not shown) is output voltage from a dimmer 1. In this case, the dimmer may be a triac dimmer.

In FIG. 1, the dimming block 10 compares line voltage Vline supplied to the LED light (not shown) with reference voltage Vth. The comparison between the line voltage Vline and the reference voltage Vth is performed by a comparator 11. The line voltage compared in the dimming block 10 is voltage sensed by, for example, the line voltage sensing block 70 of FIG. 1. Further, the dimming block 10 outputs a peak value of voltage charged according to a comparison signal Vse1 between the line voltage and the reference voltage as a first reference signal Vref1. For example, a peak value of the charging voltage may be output as the first reference signal Vref1 using a sample and hold circuit.

The dimming block 10 will be described in more detail with reference to FIG. 1. In one example, the dimming block 10 may include the comparison unit 11, a charging voltage generation unit 13, and a first sample and hold unit 15.

In this case, referring to FIGS. 1 and 2, the comparison unit 11 includes a comparator 11 to compare the line voltage Vline with the reference voltage Vth so as to be output as the comparison signal Vse1. For example, referring to FIGS. 1 and 2, the line voltage Vline sensed by the line voltage sensing block 70 is input to the comparator 11 of the comparison unit 11 through a multi pin PIN1, which is in turn compared by the comparator 11. In this case, the comparison signal Vse1 is output as high in a section in which the line voltage Vline is the reference voltage Vth or more and the comparison signal Vse1 is output as low in a section in which the line voltage Vline is lower than the reference voltage Vth.

The charging voltage generation unit 13 is supplied with current from a constant current source 131 according to the comparison signal output from the comparator 11 to perform charging. In this case, referring to FIG. 1, describing in more detail the charging voltage generation unit 13 according to one example, the charging voltage generation unit 13 may include the constant current source 131, a switch 133, and a charging capacitor Cdim 135. The constant current source 131 supplies current so that voltage is charged in the charging capacitor Cdim 135. The switch 133 is switched according to the comparison signal Vse1 output from the comparator 11. Next, the charging capacitor Cdim 135 is connected with the switch 133 in parallel. The charging capacitor Cdim 135 is charged by being supplied with current from the constant current source 131 at the time of operating a turn off of the switch 133. Describing in more detail, when the comparison signal Vse1 output from the comparator 11 is a high signal, the switch 133 may be turned-off and when the comparison signal Vse1 is a low signal, the switch 133 may be turned-on. When the switch 133 is turned-on, the current supplied from the constant current source 131 to the charging capacitor Cdim 135 is bypassed to exit to a ground. On the other hand, when the switch 133 is turned-off, the current supplied from the constant current source 131 to the charging capacitor Cdim 135 and thus, charged in the charging capacitor Cdim 135.

For example, referring to FIGS. 1 and 2, the charging capacitor Cdim 135 is charged while the comparison signal Vse1 that is the output signal from the comparator 11 becomes high. Charging voltage Vint of the charging capacitor Cdim 135 is output as shown in FIG. 2 by repeating the comparison signal Vse1 as high and low.

To be continued, describing the dimming block 10 of FIG. 1, the first sample and hold unit 15 of the dimming block 10 includes a sample and hold circuit 15 to maintain a peak value of one period of the charging voltage Vint output from the charging voltage generation unit 13 and output the peak value as the first reference signal Vref1. In this case, the first reference signal becomes a reference signal for comparing with the sensing voltage in the reference signal generation block 30. For example, referring to FIGS. 1 and 2, the charging voltage Vint is output from the charging capacitor Cdim 135. In this case, the first reference signal Vref1 is generated by performing the sample and hold.

Next, in FIG. 1, the reference signal generation block 30 compares the first reference signal Vref1 output from the dimming block 10 with the peak value of the sensing voltage CS sensing the current of the LED driving switch (not shown) to amplify errors. The peak value of the sensing voltage CS may be obtained by including the sample and hold circuit. Further, the reference signal generation block 30 multiplies the line voltage Vline by the error amplified signal so as to be output as a second reference signal.

The reference signal generation block 30 will be described in more detail with reference to FIG. 1. According to one example, the reference signal generation block 30 may include a second sample and hold circuit 31, an error amplification unit 33, an a multiplication unit 35.

The second sample and hold unit 31 includes a sample and hold circuit to maintain and output the peak value of one period of the sensing voltage CS sensing the current of the LED driving switch (not shown). The signal output from the second sample and hold unit 31 is input as the comparison signal of the error amplification unit 33. For example, the sensing voltage CS signal sensing the current of the LED driving switch (not shown) is supplied through a pin PIN2. In this case, the sensing voltage CS signal is changed according to the PWM signal as shown in FIG. 3 and therefore, a constant signal is generated for one clock by performing the sample and hold in the sample and hold circuit 31. The signal in which the peak value generated from the sample and hold circuit 31 is maintained is input to an error amplifier of the error amplification unit 33, together with the first reference signal Vref1 in FIGS. 1 and 2.

Next, the error amplification unit 33 of FIG. 1 compares the output signal from the second sample and hold unit 31 with the first reference signal Vref1 output from the dimming block 10 to amplify and output the error. For example, the first reference signal Vref1 output from the dimming block 10 is a signal output from the first sample and hold unit 15. For example, the error amplifier 33 of the error amplification unit 33 receives the signal in which the peak value of the sensing voltage CS signal of FIG. 3 is maintained and the first reference signal Vref1 of FIG. 2 to output the error amplified signal.

Next, the multiplication unit 35 of FIG. 1 multiplies the line voltage Vline by the error amplified signal output from the error amplification unit 33 so as to be output as the second reference signal Vref2. In this case, the multiplication unit 35 may be configured to include a multiplier 35. The second reference signal output from the multiplication unit 35 is input as the PWM reference signal of the PWM control block 50. For example, referring to FIGS. 1 and 3, the error amplified signal output from the error amplification unit 33 is multiplied by the line voltage Vline supplied through the multi-pin PIN1 by the multiplier of the multiplication unit 35 to generate the second reference signal Vref2 and input the generated second reference signal Vref2 as the PWM reference signal of the PWM comparator 51. The Vref2 signal of FIG. 3 is a signal by multiplying the error amplified signal by the line voltage Vline in the multiplier of FIG. 1.

In addition, referring to FIG. 1, the signal output from the error amplification unit 33 may be stored in the capacitor 37 that is connected to a ground terminal and may be provided to the multiplication unit 35. In this case, the capacitor 37 connected to the ground terminal is connected to the output terminal of the error amplifier 33 so as to be operated as an integrator together with the error amplifier 33, thereby improving the stability of the overall system.

Next, in FIG. 1, the PWM control block 50 compares the second reference signal Vref2 output from the reference signal generation block 30 with the sensing voltage CS to output the PWM signal with controlled duty.

In addition, referring to FIG. 1, in one example, the PWM control block 50 includes the PMW comparator 51 and the PWM comparator 51 receives the second reference signal Vref2 output from the reference signal generation block 30 as the PWM reference signal and receives the sensing voltage as the comparison signal to compare the second reference signal Vref2 with the sending voltage CS, thereby outputting the PWM signal with the controlled duty. For example, the PWM comparator 51 receives the second reference signal Vref2 output from the multiplication unit 35 as the PWM reference signal and receives the sensing voltage CS sensing the current of the LED driving switch (not shown) as the comparison signal to output the PWM signal.

In this case, when the sensing voltage CS signal input as the comparison signal of the PWM comparator 51 is larger than the second reference signal Vref2 input as the PWM reference signal of the PWM comparator 51, the output from the PWM comparator 51 becomes low and when the sensing voltage CS signal is smaller than the second reference signal Vref2, the output from the PWM comparator 51 becomes high.

Although not shown, the PWM control block 50 may further include a flip-flop circuit in addition to the PWM comparator 51 to output a control signal according to the PWM signal output from the PWM comparator 51. Further, in order to apply the more accurate control signal, the PWM control block 50 may further include a CMOS transistor circuit (not shown) in addition to the flip-flop circuit (not shown).

In addition, referring to FIG. 1, in one example, a circuit for driving LED light may further include a line voltage sensing block 70. The line voltage sensing block 70 senses the line voltage supplied to the LED light (not shown). The line voltage Vline sensed by the line voltage sensing block 70 is supplied to the dimming block 10 and the reference signal generation block 30. For example, the line voltage Vline sensed by the line voltage sensing block 70 is supplied to the comparison unit 11 to compare with the reference voltage Vth so as to be output as the comparison signal Vse1 and is supplied to the multiplication unit 35 to be multiplied by the error amplified signal output from the error amplification unit 33 so as to generate the second reference signal Vref2.

Next, a method for driving LED light according to a second exemplary embodiment of the present invention will be described in detail with reference to the accompanying drawings. In this case, the circuits for driving LED light according to a first exemplary embodiment of the present invention may refer to FIGS. 1 to 3 and therefore, the overlapping description thereof may be omitted.

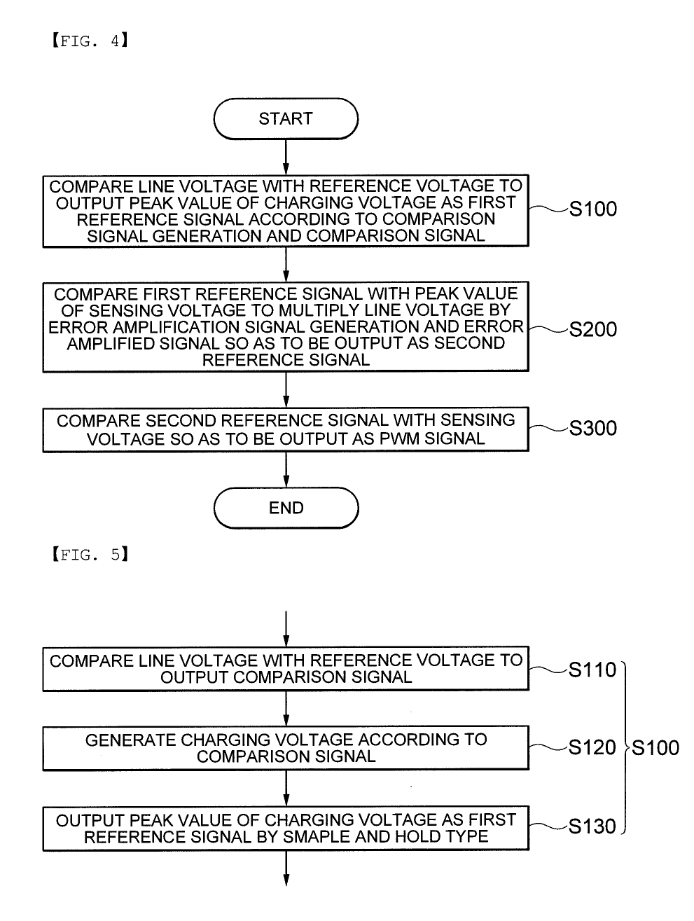

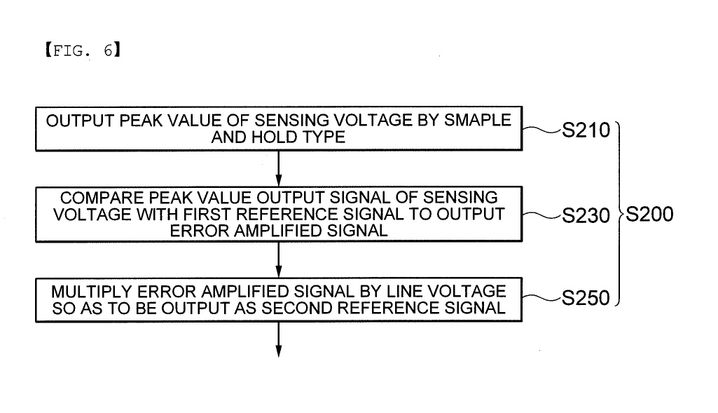

FIG. 4 is a flow chart schematically showing a method for driving LED light according to another exemplary embodiment of the present invention, FIG. 5 is a flow chart schematically showing some processes of a method for driving LED light according to another exemplary embodiment of the present invention, and FIG. 6 is a flow chart schematically showing some other processes of a method for driving LED light according to another exemplary embodiment of the present invention.

Referring to FIG. 4, the method for driving LED light according to the second exemplary embodiment of the present invention may include outputting a first reference signal (S100), generating a second reference signal (S200), and controlling PWM (S300).

In addition, in an example, the line voltage supplied to the LED light (not shown) is the output voltage from the dimmer 1. In this case, the line voltage is the voltage sensed by, for example, the line voltage sensing block 70 of FIG. 1. The dimmer 1 may be the triac dimmer.

Describing in more detail, in the outputting of the first reference signal (S100), the line voltage supplied to the LED light (not shown) compares with the reference voltage and the peak value of voltage charged according to the comparison signal is output as the first reference signal. For example, the line voltage supplied to the LED light (not shown) is the line voltage sensed by the line voltage sensing block 70 of FIG. 1.

In addition, referring to FIG. 5, in one example, the outputting of the first reference signal (S100) of FIG. 4 may include comparing (S110), generating charging voltage (S130), and performing first sample and hold (S150). In FIG. 5, in the comparing (S110), the comparison signal is output by comparing the line voltage with the reference voltage. Next, in the generating the charging voltage (S130) of FIG. 5, the charging is performed by receiving current from the constant current source 131 according to the comparison signal output from the comparing (S110). For example, referring to FIG. 1, the switch 133 is switched according to the comparison signal output from the comparing (S110) and when the switch 133 is turned-off, the charging may be performed by supplying current to the charging capacitor Cdim 135 connected with the switch 133 in parallel from the constant current source 131. Next, in the performing of the first sample and hold (S150) of FIG. 5, the peak value of one period of the charging voltage output after being charged in the generating of the charging voltage (S130) is maintained so as to be output as the first reference signal.

Referring back to FIG. 4, the method for driving LED light will be described continuously. In the generating of the second reference signal (S200) of FIG. 4, the error is amplified by comparing the first reference signal output in the outputting of the first reference signal (S100) with the peak value of the sensing voltage sensing the current of the LED driving switch (not shown) and the error amplified signal and the line voltage are multiplied by each other so as to be output as the second reference signal.

The generating of the second reference signal (S200) will be described in detail with reference to FIG. 6. In one example, the generating of the second reference signal (S200) may include performing second sample and hold (S210), amplifying an error (S230), and multiplying (S250). In detail, in the performing of the second sample and hold (S210) of FIG. 6, the peak value of one period of the sensing voltage sensing the current of the LED driving switch (not shown) is maintained and output. Next, in the amplifying of the error (S230) of FIG. 6, an error is amplified and output by comparing the output signal in the performing of the second sample and hold (S210) with the first reference signal output in the outputting of the first reference signal (S100) of FIG. 4, for example, in more detail, the first reference signal output in the performing of the first sample and hold (S150) of FIG. 5. Further, in the multiplying (S250) of FIG. 6, the error amplified signal output in the amplifying of the error (S230) and the line voltage are multiplied by each other so as to be output as the second reference signal.

Next, in the control of the PWM (S300) of FIG. 4, the PWM signal with the controlled duty is output by comparing the second reference signal output in the generating of the second reference signal (S200) with the sensing voltage. In this case, the sensing voltage is the sensing voltage sensing the current of the LED driving switch (not shown).

In addition, in one example, by the PWM comparator 51, in the controlling of the PWM (S300), the second reference signal output in the generating of the second reference signal (S200) is received as the PWM reference signal of the PWM comparator 51 and the sensing voltage is received as the comparison signal of the PWM comparator 51 to compare the second reference signal with the sensing voltage, thereby outputting the PWM signal with the controlled duty.

According to the embodiment of the present invention, the second reference signal that is the PWM reference signal is changed according to the line voltage and therefore, the triac dimmer 1 can be interchanged and the line regulation performance can be improved.

According to the exemplary embodiments of the present invention, the triac dimmer can be interchanged by changing the PWM reference signal according to the line voltage.

Further, according to the exemplary embodiments of the present invention, the dimming performance and the line regulation performance can be achieved.

It is obvious that various effects directly not stated according to various exemplary embodiment of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains rather than limiting a scope of the present invention. In addition, exemplary embodiments according to a combination of the above-mentioned configurations may be obviously implemented by those skilled in the art. Therefore, various exemplary embodiments of the present invention may be implemented in modified forms without departing from an essential feature of the present invention. In addition, a scope of the present invention should be interpreted according to claims and includes various modifications, alterations, and equivalences made by those skilled in the art.

What is claimed is:

1. A circuit for driving LED light, comprising:
a dimming block comparing line voltage supplied to the LED light with reference voltage to output a peak value of voltage charged according to a comparison signal as a first reference signal;
a reference signal generation block comparing the first reference signal output from the dimming block with a peak value of sensing voltage sensing current of an LED driving switch to amplify an error and multiplying the line voltage by the error amplified signal so as to be output as a second reference signal; and
a PWM control block comparing the second reference signal output from the reference signal generation block with the sensing voltage to output a PWM signal with controlled duty.

2. The circuit of claim 1, wherein the dimming block includes:
a comparison unit comparing the line voltage with the reference voltage to output the comparison signal;
a charging voltage generation unit receiving current from a constant current source according to the comparison signal output from the comparison unit to perform charging; and
a first sample and hold circuit unit maintaining the peak value of one period of the charging voltage output from the charging voltage generation unit so as to be output as the first reference signal.

3. The circuit of claim 2, wherein the charging voltage generation unit includes:
a constant current source supplying current;
a switch performing switching according to the comparison signal output from the comparison unit; and
a charging capacitor connected with the switch in parallel and receiving and charging the current from the constant current source at the time of operating a turn off of the switch.

4. The circuit of claim 1, wherein the reference signal generation block includes:
a second sample and hold unit maintaining and outputting the peak value of one period of the sensing voltage sensing the current of the LED driving switch;
an error amplification unit amplifying and outputting an error by comparing an output signal from the second sample and hold unit with the first reference signal output from the dimming block; and
a multiplication unit multiplying the line voltage by the error amplified signal output from the error amplification unit so as to be output as the second reference signal.

5. The circuit of claim 2, wherein the reference signal generation block includes:
a second sample and hold unit maintaining and outputting the peak value of one period of the sensing voltage sensing the current of the LED driving switch;
an error amplification unit amplifying and outputting an error by comparing an output signal from the second sample and hold unit with the first reference signal output from the first sample and hold unit; and
a multiplication unit multiplying the line voltage by the error amplified signal output from the error amplification unit so as to be output as the second reference signal.

6. The circuit of claim 1, wherein the PWM control block includes a PWM comparator, and
the PWM comparator receives the second reference signal output from the reference signal generation block as a reference signal and the sensing voltage as a comparison signal to compare the second reference signal with the sensing voltage and output the PWM singal with the controlled duty.

7. The circuit of claim 1, further comprising:
a line voltage sensing block sensing the line voltage supplied to the LED light,
wherein the line voltage supplied to the dimming block and the reference signal generation block is voltage sensed by the line voltage sensing block.

8. The circuit of claim 1, wherein the line voltage supplied to the LED light is output voltage from a dimmer.

9. The circuit of claim 2, wherein the line voltage supplied to the LED light is output voltage from a dimmer.

10. The circuit of claim 4, wherein the line voltage supplied to the LED light is output voltage from a dimmer.

11. The circuit of claim 5, wherein the line voltage supplied to the LED light is output voltage from a dimmer.

12. A method for driving LED light, comprising:
a step of outputting a first reference signal to compare line voltage supplied to the LED light with reference voltage to output a peak value of voltage charged according to a comparison signal as a first reference signal;
a step of generating a second reference signal to amplify an error by comparing the first reference signal output in the step of outputting a first reference signal with a peak value of sensing voltage sensing current of an LED driving switch and multiply the line voltage by the error amplified signal so as to be output as a second reference signal; and
a step of controlling PWM to output a PWM signal with controlled duty by comparing the second reference signal output in the step of outputting a second reference signal with the sensing voltage.

13. The method of claim 12, wherein the step of outputting a first reference signal includes:
a step of comparing the line voltage with the reference voltage to output the comparison signal;
a step of generating charging voltage to perform charging by receiving current from a constant current source according to the comparison signal output in the comparing step; and
a step of performing first sample and hold to maintain the peak value of one period of the charging voltage output after being charged in the charging voltage generating step so as to be output as the first reference signal.

14. The method of claim 12, wherein the step of generating a second reference signal includes:
a step of performing second sample and hold to maintain and output the peak value of one period of the sensing voltage sensing the current of the LED driving switch;
a step of amplifying and outputting an error by comparing a signal output in the step of performing second sample and hold with the first reference signal output in the step of outputting a first reference signal; and
a step of multiplying the line voltage by the error amplified signal output in the step of amplifying an error so as to be output as the second reference signal.

15. The method of claim 13, wherein the step of generating a second reference signal includes:
a step of performing a second sample and hold to maintain and output the peak value of one period of the sensing voltage sensing the current of the LED driving switch;
a step of amplifying and outputting an error by comparing a signal output in the step of performing second sample and hold with the first reference signal output in the step of performing first sample and hold; and
a step of multiplying the line voltage by the error amplified signal output in the step of amplifying an error so as to be output as the second reference signal.

16. The method of claim 12, wherein in the step of controlling PWM, by the PWM comparator, the second reference signal output in the second reference signal generating step is received as a reference signal of a PWM comparator and the sensing voltage is received as a comparison signal of the PWM comparator to compare the second reference signal with the sensing voltage and output the PWM signal with the controlled duty.

17. The method of claim 12, wherein the line voltage supplied to the LED light is output voltage from a dimmer.

18. The method of claim 13, wherein the line voltage supplied to the LED light is output voltage from a dimmer.

19. The method of claim 14, wherein the line voltage supplied to the LED light is output voltage from a dimmer.
